(19) United States
(12) Patent Application Publication
(10) Pub. No.: US 2025/0086504 A1
(43) Pub. Date: Mar. 13, 2025

(54) SYSTEMS AND METHODS FOR TRAINING MACHINE LEARNING ALGORITHMS FOR ANALYTE DETECTION

(71) Applicant: Know Labs, Inc., Seattle, WA (US)

(72) Inventors: Steven Kent, Seattle, WA (US); Dominic KLYVE, Seattle, WA (US); Steve LOWE, Seattle, WA (US)

(21) Appl. No.: 18/585,614

(22) Filed: Feb. 23, 2024

Related U.S. Application Data
(60) Provisional application No. 63/504,342, filed on May 25, 2023.

(51) Int. Cl. G06N 20/00; G06N 3/08

(52) U.S. Cl. CPC G06N 20/00; G06N 3/08

(57) ABSTRACT

A machine learning algorithm can be trained to process signals received from a non-invasive sensor to determine an analyte. The machine learning algorithm can be a neural network trained using data obtained from the non-invasive sensor and associated analyte detection results from another sensor. The features of the data can be smoothed using a Savitzky-Golay filter, scaled, and the feature space can also be reduced, such as by Gaussian random projection. The training of the algorithm can be tested using other data obtained from the non-invasive sensor and associated analyte detection results from another sensor. Once trained, the machine learning model is used to determine levels of an analyte from signals received at a non-invasive sensor in response to transmission of a transmit signal into a subject.

### FIELD

This disclosure is directed to systems and methods for detecting analytes, particularly processing signals from non-invasive detection methods to obtain analyte levels using machine learning.

### BACKGROUND

There is interest in being able to detect and/or measure an analyte within a target. One example is measuring glucose in biological tissue. In the example of measuring glucose in a patient, current analyte measurement methods are invasive in that they perform the measurement on a bodily fluid such as blood for fingerstick or laboratory-based tests, or on fluid that is drawn from the patient often using an invasive transcutaneous device. There are non-invasive methods that claim to be able to perform glucose measurements in biological tissues. However, many of the non-invasive methods generally suffer from: lack of specificity to the analyte of interest, such as glucose; interference from temperature fluctuations; interference from skin compounds (i.e., sweat) and pigments; and complexity of placement, i.e. the sensing device resides on multiple locations on the patient's body. Further, non-invasive measurements may be limited in the ability to measure certain analytes and/or be used for diagnosis of particular conditions.

### SUMMARY

This disclosure is directed to systems and methods for detecting analytes, particularly processing signals from non-invasive detection methods to obtain analyte levels using machine learning.

By training a machine learning algorithm, complex signals such as radio frequency (RF) responses to transmitted RF signals can be processed to determine amounts of particular analytes with improved accuracy. This can support the use of non-invasive sensors to accurately detect amounts of such analytes. The machine learning algorithm can be trained by capturing data using the non-invasive sensor, associating the captured data with measurements from that subject and time, processing the associated data to smooth, scale, and reduce the number of features, and providing the processed data to the machine learning algorithm to train the machine learning algorithm.

In an embodiment, a method of detecting a level of an analyte includes transmitting a transmit signal into a subject using a transmit antenna of a non-invasive sensor, obtaining a response signal from the subject using a receive antenna of the non-invasive sensor; and processing the response signal using a machine learning algorithm to determine the level of the analyte. The machine learning algorithm is trained by transmitting a frequency sweep into a test subject using a transmit antenna of a test non-invasive sensor, obtaining a test response to the frequency sweep from the test subject using a receive antenna of the test non-invasive sensor, obtaining a test analyte level in the test subject using a reference sensor, associating the test response with the test analyte level, processing features of the test response to generate training data, and inputting the training data into the machine learning algorithm.

In an embodiment, the machine learning algorithm is a neural network. In an embodiment, the neural network includes two blocks each with a one-dimensional convolution layer, the two blocks followed by a pooling layer, a dropout layer, and a neuron trained to predict the level of the analyte based on the response signal. In an embodiment, the processing of the features includes smoothing of the features using a Savitzky-Golay filter. In an embodiment, the parameters of the Savitzky-Golay filter include a window length of 2000, a polynomial order of 4, a derivative order of 1, and using the extension mode nearest. In an embodiment, the processing of the features includes reducing a feature space using Gaussian random projection and/or a Gaussian mixture model. In an embodiment, the feature space is reduced to between 2 and 1024 features. In an embodiment, a range of frequencies of the frequency sweep is from about 10 kHz to about 100 GHz. In an embodiment, a range of frequencies of the frequency sweep is from about 300 MHz to about 6 GHz. In an embodiment, a range of frequencies of the frequency sweep is from about 100 MHz to about 4 GHz. In an embodiment, a range of frequencies of the frequency sweep is from 500 MHz to 3000 MHz. In an embodiment, the frequency sweep is at 1 MHz intervals within the range of frequencies. In an embodiment, following training of the machine learning algorithm, the machine learning algorithm is tested by obtaining a validation signal using a validation non-invasive sensor, obtaining a corresponding validation analyte level, determining an output analyte level based on the validation signal, using the machine learning algorithm, and comparing the output analyte level with the validation analyte level. In an embodiment, at least a portion of the response signal is received from interstitial fluid of the subject. In an embodiment, processing features of the test response include averaging features over at least one of a frequency domain or a time domain. In an embodiment, the machine learning algorithm is a light gradient boosting machine model. In an embodiment, a loss function of the light gradient boosting machine model is based on a mean average relative difference relative to the test analyte level.

In an embodiment, a method of training a machine learning algorithm to detect a level of an analyte in a subject can include transmitting a frequency sweep into a test subject using a transmit antenna of a test non-invasive sensor, obtaining a test response to the frequency sweep from the test subject using a receive antenna of the test non-invasive sensor, obtaining a test analyte level in the test subject using a reference sensor, associating the test response with the test analyte level, processing features of the test response to generate training data and inputting the training data into the machine learning algorithm.

In an embodiment, the processing of the features includes smoothing of the features using a Savitzky-Golay filter. In an embodiment, the parameters of the Savitzky-Golay filter include a window length of 2000, a polynomial order of 4, a derivative order of 1, and using the extension mode nearest. In an embodiment, the processing of the features includes reducing a feature space using Gaussian random projection and/or a Gaussian mixture model. In an embodiment, the feature space is reduced to between 2 and 1024 features. In an embodiment, the frequency sweep is at 1 MHz intervals within a range of frequencies. In an embodiment, processing features of the test response includes averaging features over at least one of a frequency domain or a time domain.

In an embodiment, a non-invasive analyte sensing system can include a transmit antenna configured to transmit a transmit signal into a subject and a receive antenna configured to obtain a response signal from the subject. A controller can be configured to process the response signal using a machine learning algorithm to determine a level of an analyte in the subject. In an embodiment, the machine learning algorithm is a neural network. In an embodiment, the machine learning algorithm is a light gradient boosting machine model.

### BRIEF DESCRIPTION OF DRAWINGS

FIG. 1 shows a sensor according to an embodiment.

FIGS. 2A-2C show systems for obtaining training data according to embodiments.

FIG. 3 shows a method for training a machine learning algorithm according to an embodiment.

FIG. 4 shows a neural network according to an embodiment.

FIG. 5 shows a method for testing a trained machine learning algorithm according to an embodiment.

FIG. 6 shows a method of determining a quantity of an analyte according to an embodiment.

FIG. 7 shows an example of a tree resulting from use of a lightGBM model.

FIG. 8 shows model fit over time for training and test sets compared to the reference values.

Like reference numbers represent like parts throughout.

### DETAILED DESCRIPTION

This disclosure is directed to systems and methods for detecting analytes, particularly processing signals from non-invasive detection methods to obtain analyte levels using machine learning.

Signals detected by a receive antenna of a sensor can be used to train a machine learning algorithm such as a neural network and analyzed to detect the analyte using the trained machine learning algorithm. Examples of sensors that obtain signals for such training and/or analysis include the sensors described in U.S. Pat. Nos. 10,548,503, 11,063,373, 11,058,331, 11,033,208, 11,284,819, 11,284,820, 10,548,503, 11,234,619, 11,031,970, 11,223,383, 11,058,317, 11,193,923, 11,234,618, and 11,529,077, the entire contents of which are incorporated herein by reference.

In one embodiment, the analyte sensor described herein can be used to detect the presence of at least one analyte in a target. In another embodiment, the analyte sensor described herein can detect an amount or a concentration of the at least one analyte in the target. The target can be any target containing at least one analyte of interest that one may wish to detect. The target can be human or non-human, animal or non-animal, biological or non-biological. For example, the target can include, but is not limited to, human tissue, animal tissue, plant tissue, an inanimate object, soil, a fluid, genetic material, or a microbe. Non-limiting examples of targets include, but are not limited to, one or more of blood, interstitial fluid, cerebral spinal fluid, lymph fluid or urine, human tissue, animal tissue, plant tissue, an inanimate object, soil, genetic material, or a microbe.

The analyte(s) can be any analyte that one may wish to detect. The analyte can be human or non-human, animal or non-animal, biological or non-biological. For example, the analyte(s) can include, but is not limited to, one or more of glucose, blood alcohol, oxygen or an indicator thereof, white blood cells, or luteinizing hormone. The analyte(s) can include, but is not limited to, a chemical, a combination of chemicals, a virus, a bacteria, or the like. The analyte can be a chemical included in another medium, with non-limiting examples of such media including a fluid containing the at least one analyte, for example blood, interstitial fluid, cerebral spinal fluid, lymph fluid or urine, human tissue, animal tissue, plant tissue, an inanimate object, soil, genetic material, or a microbe. In an embodiment, the analyte may be simultaneously detected from both blood and interstitial fluid. The analyte(s) may also be a non-human, non-biological particle such as a mineral or a contaminant.

The analyte(s) can include, for example, naturally occurring substances, artificial substances, metabolites, and/or reaction products. As non-limiting examples, the at least one analyte can include, but is not limited to, insulin, acarboxyprothrombin; acylcarnitine; adenine phosphoribosyl transferase; adenosine deaminase; albumin; alpha-fetoprotein; amino acid profiles (arginine (Krebs cycle), histidine/urocanic acid, homocysteine, phenylalanine/tyrosine, tryptophan); andrenostenedione; antipyrine; arabinitol enantiomers; arginase; benzoylecgonine (cocaine); biotinidase; biopterin; c-reactive protein; carnitine; pro-BNP; BNP; troponin; carnosinase; CD4; ceruloplasmin; chenodeoxycholic acid; chloroquine; cholesterol; cholinesterase; conjugated 1-β hydroxy-cholic acid; cortisol; creatine kinase; creatine kinase MM isoenzyme; cyclosporin A; d-penicillamine; de-ethylchloroquine; dehydroepiandrosterone sulfate; DNA (acetylator polymorphism, alcohol dehydrogenase, alpha 1-antitrypsin, cystic fibrosis, Duchenne/Becker muscular dystrophy, analyte-6-phosphate dehydrogenase, hemoglobin and variants thereof including hemoglobin A, hemoglobin S, hemoglobin C, hemoglobin D, hemoglobin E, hemoglobin F, D-Punjab, and beta-thalassemia, particular conformations or conjugations of hemoglobin such as oxyhemoglobin, deoxyhemoglobin, carboxyhemoglobin, and the like; hepatitis B virus; HCMV, HIV-1, HTLV-1, Leber hereditary optic neuropathy, MCAD, RNA, PKU, Plasmodium vivax, sexual differentiation, 21-deoxycortisol); desbutylhalofantrine; dihydropteridine reductase; diptheria/tetanus antitoxin; erythrocyte arginase; erythrocyte protoporphyrin; esterase D; fatty acids/acylglycines; free β-human chorionic gonadotropin; free erythrocyte porphyrin; free thyroxine (FT4); free tri-iodothyronine (FT3); fumarylacetoacetase; galactose/gal-1-phosphate; galactose-1-phosphate uridyltransferase; gentamicin; analyte-6-phosphate dehydrogenase; glutathione; glutathione perioxidase; glycocholic acid; glycosylated hemoglobin; halofantrine; hemoglobin variants; hexosaminidase A; human erythrocyte carbonic anhydrase I; 17-alpha-hydroxyprogesterone; hypoxanthine phosphoribosyl transferase; immunoreactive trypsin; lactate; lead; lipoproteins ((a), B/A-1, β); lysozyme; mefloquine; netilmicin; phenobarbitone; phenytoin; phytanic/pristanic acid; progesterone; prolactin; prolidase; purine nucleoside phosphorylase; quinine; reverse tri-iodothyronine (rT3); selenium; serum pancreatic lipase; sissomicin; somatomedin C; specific antibodies (adenovirus, anti-nuclear antibody, anti-zeta antibody, arbovirus, Aujeszky's disease virus, dengue virus, Dracunculus medinensis, Echinococcus granulosus, Entamoeba histolytica, enterovirus, Giardia duodenalisa, Helicobacter pylori, hepatitis B virus, herpes virus, HIV-1, IgE (atopic disease), influenza virus, Leishmania donovani, leptospira, measles/mumps/rubella, Mycobacterium leprae, Mycoplasma pneumoniae, Myoglobin, Onchocerca volvulus, parainfluenza virus, Plasmodium falciparum, polio virus, Pseudomonas aeruginosa, respiratory syncytial virus, rickettsia (scrub typhus), Schistosoma mansoni, Toxoplasma gondii, Trepenoma pallidium, Trypanosoma cruzi/rangeli, vesicular stomatis virus, Wuchereria bancrofti, yellow fever virus); specific antigens (hepatitis B virus, HIV-1); succinylacetone; sulfadoxine; theophylline; thyrotropin (TSH); thyroxine (T4); thyroxine-binding globulin; trace elements; transferrin; UDP-galactose-4-epimerase; urca; uroporphyrinogen I synthase; vitamin A; white blood cells; zinc protoporphyrin; prostaglandins such as PGF2α and PGE2; hormones such as estrogen, progesterone, and/or follicle stimulating hormone (FSH).

The analyte(s) can also include one or more chemicals introduced into the target. The analyte(s) can include a marker such as a contrast agent, a radioisotope, or other chemical agent. The analyte(s) can include a fluorocarbon-based synthetic blood. The analyte(s) can include a drug or pharmaceutical composition, with non-limiting examples including ethanol or other alcohols; ketones; cannabis (marijuana, tetrahydrocannabinol, hashish); inhalants (nitrous oxide, amyl nitrite, butyl nitrite, chlorohydrocarbons, hydrocarbons); cocaine (crack cocaine); stimulants (amphetamines, methamphetamines, Ritalin, Cylert, Preludin, Didrex, PreState, Voranil, Sandrex, Plegine); depressants (barbiturates, methaqualone, tranquilizers such as Valium, Librium, Miltown, Serax, Equanil, Tranxene); hallucinogens (phencyclidine, lysergic acid, mescaline, peyote, psilocybin); narcotics (heroin, codeine, morphine, opium, meperidine, Percocet, Percodan, Tussionex, Fentanyl, Darvon, Talwin, Lomotil); designer drugs (analogs of fentanyl, meperidine, amphetamines, methamphetamines, and phencyclidine, for example, Ecstasy); anabolic steroids; and nicotine. The analyte(s) can include other drugs or pharmaceutical compositions. The analyte(s) can include neurochemicals or other chemicals generated within the body, such as, for example, ascorbic acid, uric acid, dopamine, noradrenaline, 3-methoxytyramine (3MT), 3,4-Dihydroxyphenylacetic acid (DOPAC), Homovanillic acid (HVA), 5-Hydroxytryptamine (5HT), and 5-Hydroxyindoleacetic acid (FHIAA).

In an embodiment, the analyte(s) are one or more analytes that can be used to determine an oxygen level in a subject. The analytes can be, for example, elemental oxygen, oxyhemoglobin, deoxyhemoglobin, or any other suitable analyte indicative of or a proxy for the oxygen level in the subject. The oxygen level can be an overall level of oxygen or analyte(s) indicative of or a proxy for oxygen by itself, or can be a ratio such as a ratio of oxyhemoglobin to deoxyhemoglobin.

In an embodiment, the analyte(s) can include one or more indicators for determination of hydration of a subject. The analyte(s) can include, for example, hemoglobin, red blood cells as a whole, one or more hormones, sodium, one or more solutes from which osmolarity can be determined, or the like. The amount of the analyte(s) can be used to determine one or more indicia of hydration, such as concentrations of one or more analytes, hematocrit, osmolarity, or any other suitable measurement of a hydration level of the subject. The osmolarity can be an osmolarity of one or more of plasma, interstitial fluid, saliva, urine, or the like. In an embodiment, a sensor can be positioned such that the results of detection are indicative of the presence or amount of analytes in the bladder of the subject, such that urine parameters related to hydration such as urine osmolarity can be determined. In an embodiment, the sensor can be positioned such that results of detection are indicative of the presence or amount of analytes in saliva. A hydration level can be determined based on the one or more indicators, for example by comparing osmolarity or hematocrit to reference values. The reference values can be reference values specific to the subject, general reference values, reference values for a group that the subject belongs to, or the like. In an embodiment, the sensor can detect the one or more analytes in the subject non-invasively. In an embodiment, the sensor can detect the one or more analytes in a sample obtained from the subject, such as a blood, urine, or saliva sample. The sample can have a predetermined mass or volume.

In an embodiment, the sensor described herein can be incorporated into a wearable device such as a ring, a watch, or any other suitable wearable device that is worn on the user's body. The wearable device may be configured to be worn by the user over a longer period of time, for example a watch, a ring, or the like. Alternatively, the wearable device may be configured to be temporarily worn, for example only during one or more analyte readings after which the wearable device is removed. In an embodiment, the sensor described herein can be configured as a non-wearable device. For example, the sensor can be configured as a device that a user holds or presses against a body part during an analyte reading, or a body part is pressed against the sensor, during an analyte reading.

The device including the sensor, whether wearable or non-wearable, can also be configured to be capable of detecting one or more physiological parameters such as user heart rate, user blood pressure, user body temperature, user calorie consumption, user glucose level, one or more hormone levels, bioelectric impedance, or the like. One or more of the physiological parameters can be detected directly using the sensor and/or determined based on detection of one or more analytes by the sensor. In an embodiment, one or more of the physiological parameters can be detected or determined using one or more additional physiological sensors included in the device in addition to the sensor described herein. The one or more additional physiological sensors can be any suitable physiological sensor for the particular physiological parameter to be sensed. In an embodiment, one or more of the physiological parameters can be determined based on a presence or amount of one or more analytes detected by the sensor and one or more additional measurements made by one or more additional physiological sensors included in the device. The device can also include one or more additional functionalities including, but not limited to, a camera; an accelerometer; a pedometer; a fitness/activity tracker; an altimeter; a barometer; a compass; a global positioning system; a sleep monitor; a fall sensor; a microphone; a speaker; and others.

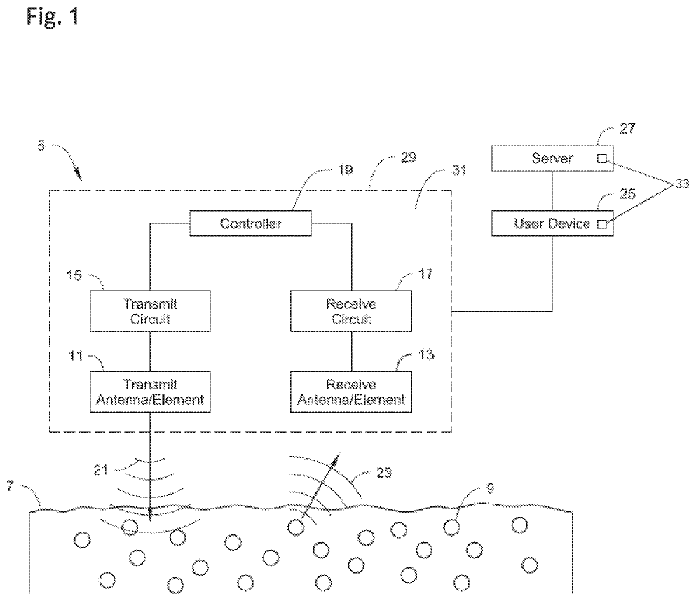

FIG. 1 shows a sensor at a measurement location according to an embodiment. An embodiment of a non-invasive analyte sensor system with a non-invasive analyte sensor 5 is illustrated. The sensor 5 is depicted relative to a target 7 that contains one or more analyte(s) of interest 9. In this example, the sensor 5 is depicted as including an antenna array that includes a transmit antenna/element 11 (hereinafter “transmit antenna 11”) and a receive antenna/element 13 (hereinafter “receive antenna 13”). The sensor 5 further includes a transmit circuit 15, a receive circuit 17, and a controller 19. As discussed further below, the sensor 5 can also include a power supply, such as a battery (not shown in FIG. 1). Sensor 5 can be a non-invasive sensor. Non-invasive sensing can include sensing without disruption to tissue of a subject, for example without requiring injection, implantation into the subject, or the like. It is understood that while sensor 5 is a non-invasive sensor capable of non-invasive sensing, it can also be used to detect the one or more analytes in samples that have been obtained from a subject such as blood or tissue samples.

The analyte(s) of interest 9 are to be detected at target 7. The target can be one or more parts of a subject using the sensor 5. For example, the target 7 can be any one or more of, for example, the lower left leg, upper left leg, lower right leg, upper right leg, lower left arm, upper left arm, groin, abdomen, chest, neck, and/or the head of the subject using sensor 5.

The transmit antenna 11 is positioned, arranged and configured to transmit a signal 21 that is the radio frequency (RF) or microwave range of the electromagnetic spectrum into the target 7. The transmit antenna 11 can be an electrode or any other suitable transmitter of electromagnetic signals in the radio frequency (RF) or microwave range. The transmit antenna 11 can have any arrangement and orientation relative to the target 7 that is sufficient to allow the analyte sensing to take place. In one non-limiting embodiment, the transmit antenna 11 can be arranged to face in a direction that is substantially toward the target 7.

The signal 21 transmitted by the transmit antenna 11 is generated by the transmit circuit 15 which is electrically connectable to the transmit antenna 11. The transmit circuit 15 can have any configuration that is suitable to generate a transmit signal to be transmitted by the transmit antenna 11. Transmit circuits for generating transmit signals in the RF or microwave frequency range are well known in the art. In one embodiment, the transmit circuit 15 can include, for example, a connection to a power source, a frequency generator, and optionally filters, amplifiers or any other suitable elements for a circuit generating an RF or microwave frequency electromagnetic signal. In an embodiment, the signal generated by the transmit circuit 15 includes a frequency in the range from about 10 kHz to about 100 GHz. In another embodiment, the frequency can be in a range from about 300 MHz to about 6000 MHz. In an embodiment, the transmit circuit 15 can be configured to sweep through a range of frequencies that are within the range of about 10 kHz to about 100 GHz, or in another embodiment a range of about 300 MHz to about 6000 MHz.

The receive antenna 13 is positioned, arranged, and configured to detect one or more electromagnetic response signals 23 that result from the transmission of the transmit signal 21 by the transmit antenna 11 into the target 7 and impinging on the analyte(s) 9. The receive antenna 13 can be an electrode or any other suitable receiver of electromagnetic signals in the radio frequency (RF) or microwave range. In an embodiment, the receive antenna 13 is configured to detect electromagnetic signals including a frequency in the range from about 10 kHz to about 100 GHz, or in another embodiment a range from about 300 MHz to about 6000 MHz. The receive antenna 13 can have any arrangement and orientation relative to the target 7 that is sufficient to allow detection of the response signal(s) 23 to allow the analyte sensing to take place. In one non-limiting embodiment, the receive antenna 13 can be arranged to face in a direction that is substantially toward the target 7. When the target 7 is a living subject or a part thereof, the signal obtained by receive antenna 13 can be indicative of the analyte(s) present in at least both the blood and the interstitial fluid of the living subject.

The receive circuit 17 is electrically connectable to the receive antenna 13 and conveys the received response from the receive antenna 13 to the controller 19. The receive circuit 17 can have any configuration that is suitable for interfacing with the receive antenna 13 to convert the electromagnetic energy detected by the receive antenna 13 into one or more signals reflective of the response signal(s) 23. The construction of receive circuits are well known in the art. The receive circuit 17 can be configured to condition the signal(s) prior to providing the signal(s) to the controller 19, for example through amplifying the signal(s), filtering the signal(s), or the like. Accordingly, the receive circuit 17 may include filters, amplifiers, or any other suitable components for conditioning the signal(s) provided to the controller 19.

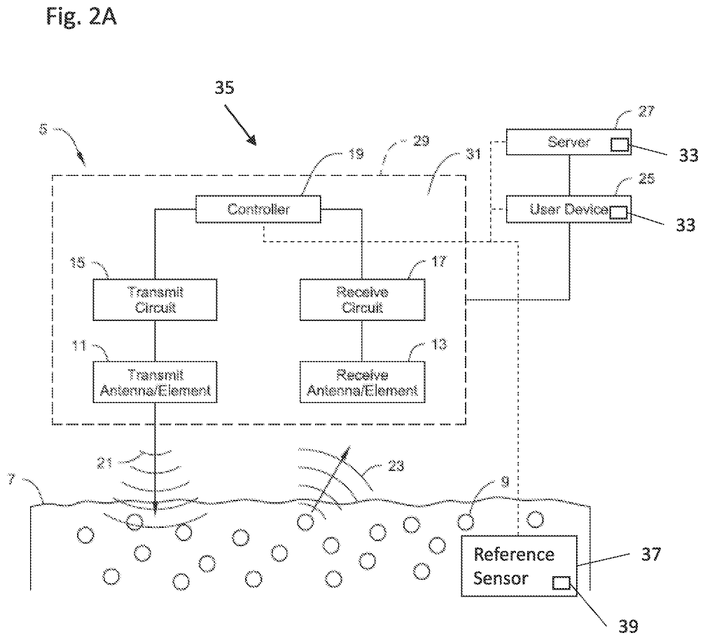

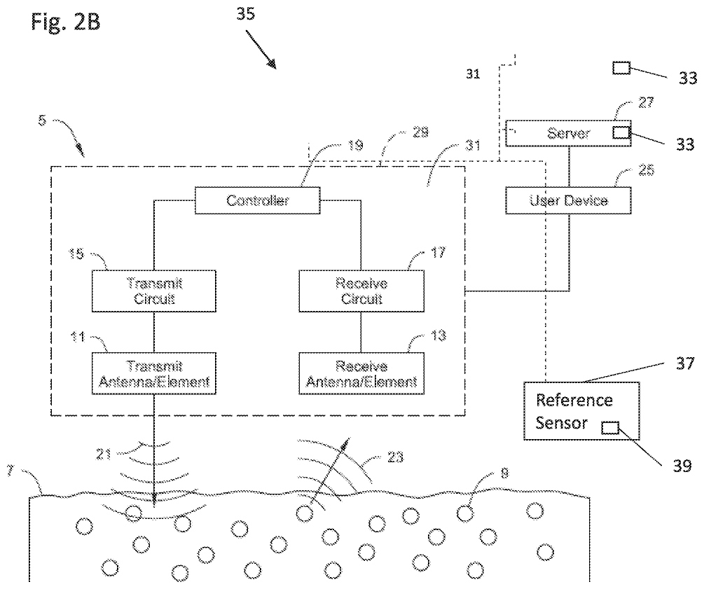

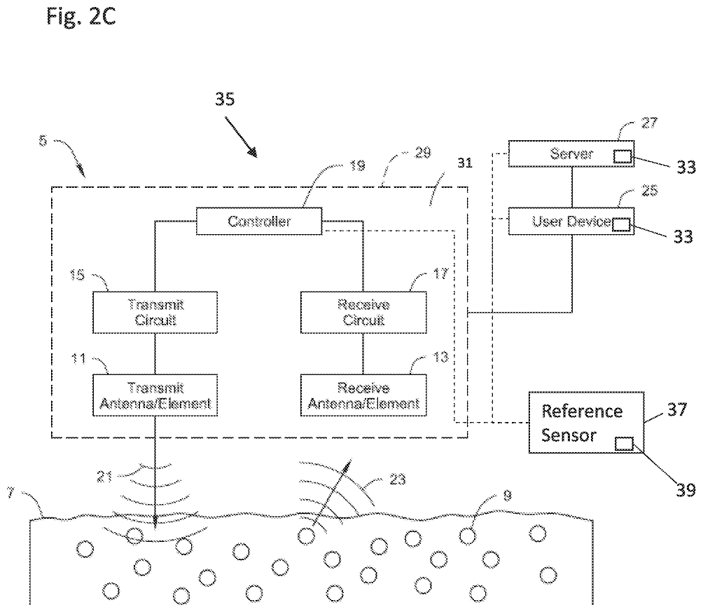

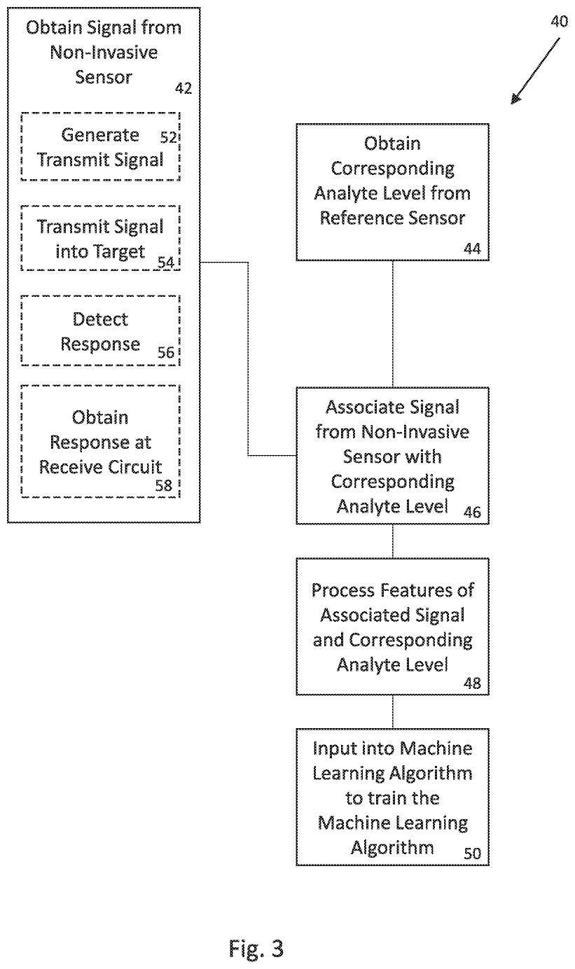

The controller 19 controls the operation of the sensor 5. The controller 19, for example, can direct the transmit circuit 15 to generate a transmit signal to be transmitted by the transmit antenna 11. The controller 19 further receives signals from the receive circuit 17. The controller 19 can optionally process the signals from the receive circuit 17 to detect the analyte(s) 9 in the target 7, for example using a machine learning model such as a neural network, to determine a level of an analyte in the target 7. The machine learning model can be trained using a system according to any of FIGS. 2A-2C and described below, and/or according to method 40 shown in FIG. 3 and described below.

In one embodiment, the controller 19 may optionally be in communication with at least one external device 25 such as a user device and/or a remote server 27, for example through one or more wireless connections such as Bluetooth, wireless data connections such a 4G, 5G, LTE or the like, or Wi-Fi. If provided, the external device 25 and/or remote server 27 may process (or further process) the signals that the controller 19 receives from the receive circuit 17, for example to detect the analyte(s) 9, to obtain training or validation data for use in training or testing of a machine learning algorithm, or the like. If provided, the external device 25 may be used to provide communication between the sensor 5 and the remote server 27, for example using a wired data connection or via a wireless data connection or Wi-Fi of the external device 25 to provide the connection to the remote server 27.

In an embodiment, controller 19 can be configured to determine a presence or amount of the one or more analytes at the target based on the received response signal. In an embodiment, the external device 25 or remote server 27 can include a controller 33 configured to determine the presence or amount of the one or more analytes at the target based on the received response signal. The determination of the presence or amount of the one or more analytes can be determined by processing the response signal using a machine learning model, for example a machine learning model trained according to method 40 as discussed below and shown in FIG. 3. In an embodiment, the controller(s) 33 can process the response signal to generate training and/or validation data for the training or testing of a machine learning algorithm.

With continued reference to FIG. 1, the sensor 5 may include a sensor housing 29 (shown in dashed lines) that defines an interior space 31. Components of the sensor 5 may be attached to and/or disposed within the housing 29. For example, the transmit antenna 11 and the receive antenna 13 are attached to the housing 29. In some embodiments, the antennas 11, 13 may be entirely or partially within the interior space 31 of the housing 29. In some embodiments, the antennas 11, 13 may be attached to the housing 29 but at least partially or fully located outside the interior space 31. In some embodiments, the transmit circuit 15, the receive circuit 17 and the controller 19 are attached to the housing 29 and disposed entirely within the sensor housing 29. In an embodiment, the sensor housing 29 is included in a wearable device. In an embodiment, the sensor housing 29 is included in a mobile computing device such as a smartphone, a tablet computer, or a laptop computer. In an embodiment, the sensor housing is included in a sensing station or in a sensing device such as a blood pressure cuff.

The receive antenna 13 is decoupled or detuned with respect to the transmit antenna 11 such that electromagnetic coupling between the transmit antenna 11 and the receive antenna 13 is reduced. The decoupling of the transmit antenna 11 and the receive antenna 13 increases the portion of the signal(s) detected by the receive antenna 13 that is the response signal(s) 23 from the target 7, and minimizes direct receipt of the transmitted signal 21 by the receive antenna 13. The decoupling of the transmit antenna 11 and the receive antenna 13 results in transmission from the transmit antenna 11 to the receive antenna 13 having a reduced forward gain (S₂₁) and an increased reflection at output (S₂₂) compared to antenna systems having coupled transmit and receive antennas.

In an embodiment, coupling between the transmit antenna 11 and the receive antenna 13 is 95% or less. In another embodiment, coupling between the transmit antenna 11 and the receive antenna 13 is 90% or less. In another embodiment, coupling between the transmit antenna 11 and the receive antenna 13 is 85% or less. In another embodiment, coupling between the transmit antenna 11 and the receive antenna 13 is 75% or less.

Any technique for reducing coupling between the transmit antenna 11 and the receive antenna 13 can be used. For example, the decoupling between the transmit antenna 11 and the receive antenna 13 can be achieved by one or more intentionally fabricated configurations and/or arrangements between the transmit antenna 11 and the receive antenna 13 that is sufficient to decouple the transmit antenna 11 and the receive antenna 13 from one another.

For example, in one embodiment described further below, the decoupling of the transmit antenna 11 and the receive antenna 13 can be achieved by intentionally configuring the transmit antenna 11 and the receive antenna 13 to have different geometries from one another. Intentionally different geometries refers to different geometric configurations of the transmit and receive antennas 11, 13 that are intentional. Intentional differences in geometry are distinct from differences in geometry of transmit and receive antennas that may occur by accident or unintentionally, for example due to manufacturing errors or tolerances.

Another technique to achieve decoupling of the transmit antenna 11 and the receive antenna 13 is to provide appropriate spacing between each antenna 11, 13 that is sufficient to decouple the antennas 11, 13 and force a proportion of the electromagnetic lines of force of the transmitted signal 21 into the target 7 thereby minimizing or eliminating as much as possible direct receipt of electromagnetic energy by the receive antenna 13 directly from the transmit antenna 11 without traveling into the target 7. The appropriate spacing between each antenna 11, 13 can be determined based upon factors that include, but are not limited to, the output power of the signal from the transmit antenna 11, the size of the antennas 11, 13, the frequency or frequencies of the transmitted signal, and the presence of any shielding between the antennas. This technique helps to ensure that the response detected by the receive antenna 13 is measuring the analyte(s) 9 and is not just the transmitted signal 21 flowing directly from the transmit antenna 11 to the receive antenna 13. In some embodiments, the appropriate spacing between the antennas 11, 13 can be used together with the intentional difference in geometries of the antennas 11, 13 to achieve decoupling.

In one embodiment, the transmit signal (or each of the transmit signals) can be transmitted over a transmit time that is less than, equal to, or greater than about 300 ms. In another embodiment, the transmit time can be than, equal to, or greater than about 200 ms. In still another embodiment, the transmit time can be less than, equal to, or greater than about 30 ms. The transmit time could also have a magnitude that is measured in seconds, for example 1 second, 5 seconds, 10 seconds, or more. In an embodiment, the same transmit signal can be transmitted multiple times, and then the transmit time can be averaged. In another embodiment, the transmit signal (or each of the transmit signals) can be transmitted with a duty cycle that is less than or equal to about 50%.

Further information on the sensor 5 and its components and variations thereof can be found in U.S. Pat. Nos. 11,063,373, 11,234,619, 11,031,970, 11,223,383, 11,058,317, 11,058,331, 11,193,923, 10,548,503, 11,330,997, 11,033,208, 11,234,618, 11,284,819, and 11,284,820, the entire contents of which are incorporated herein by reference in their entirety.

In an embodiment, the sensor 5 can be incorporated into a wearable device such as a ring, a watch, or any other suitable wearable device. For example, housing 29 can be provided on or in the wearable device. The wearable device including sensor 5 can be capable of detecting physiological parameters such as heart rate, blood pressure, oxygen level, hydration level, body temperature, calorie consumption, glucose level, one or more hormone levels, or the like. One or more of the physiological parameters can be detected using sensor 5 or determined based on detection of one or more analytes by the sensor 5. In an embodiment, one or more of the physiological parameters can be detected or determined using another sensor included in the wearable device in addition to the sensor 5. This other sensor can be any suitable sensor for the particular physiological parameter. In an embodiment, one or more of the physiological parameters can be determined based on a presence or amount of one or more analytes detected by the sensor 5 and one or more additional measurements made by another sensor included in the wearable device.

Referring now to FIGS. 2A-2C, each shows an embodiment of a system for obtaining training data for training a machine learning algorithm. The system 35 can include a non-invasive analyte sensor 5 as shown in FIG. 1 and described above and a reference sensor 37. Reference sensor 37 is a sensor configured to detect one or more analytes within the subject including target 7 that a machine learning algorithm is being trained to detect based on the signals obtained by non-invasive analyte sensor 5. In an embodiment, the reference sensor 37 can be a glucose sensor when used to train the machine learning algorithm to determine glucose based on signals from the sensor 5. The reference sensor 37 can be, for example, an invasive sensor. Where reference sensor 37 is an invasive sensor, the reference sensor 37 can result in disruption to tissue of the subject including target 7 as part of obtaining measurements from the reference sensor 37. The disruptions can be, for example, obtaining a tissue sample, being implanted into the subject, requiring a withdrawal of a fluid sample such as blood through a finger stick or other such method, or the like. In an embodiment, the reference sensor 37 is an implantable sensor, for example as shown in FIG. 2A. In an embodiment, the reference sensor 37 can reside on or under a subject's skin during use, for example as shown in FIG. 2B. Non-limiting examples of invasive sensors include glucose sensors such as the Dexcom® G6 CGM or the Freestyle Libre™. In an embodiment, the reference sensor 37 is an implantable glucose sensor. In an embodiment, the reference sensor 37 detects the analyte based on a sample obtained from the subject including target 7. In an embodiment, the reference sensor 37 can be separate from the subject but still sense in an invasive manner, for example as shown in FIG. 2C. For example, the reference sensor 37 can be configured to receive a sample such as a fluid sample and/or a tissue sample obtained from the subject. In an embodiment, the reference sensor 37 can be any suitable reference device for detection of the analyte for which the machine learning algorithm is to be trained, as set forth by any applicable clinical or regulatory standards, such as a laboratory-based glucose measurement. In an embodiment, the reference sensor 37 can be a glucose sensor configured to measure glucose based on a blood sample, such as a finger-stick glucose sensor. Non-limiting examples of glucose sensors that can be used as reference sensor 37 include the Dexcom® G6 CGM or the Freestyle Libre™ glucose sensors.

Reference sensor 37 can be configured to communicate with one or more of the non-invasive sensor 5, the external device 25, and/or remote server 27. The communication can be any suitable communication of signals to and/or from the invasive sensor 31, non-invasive sensor 5, external device 25, and/or remote server 27, such as wired or wireless communications. In an embodiment, reference sensor 31 includes a controller 39. Controller 39 can be configured to receive data from sensor 5 and process the data obtained at reference sensor 37 and the data received from non-invasive sensor 5, for example to generate training or validation data for training or testing of a machine learning algorithm and/or to perform the training or testing of the machine learning algorithm. In an embodiment, controller 33 included in external device 25 or remote server 27 can be configured to receive data from sensor 5 and process the data obtained at reference sensor 37 and the data received from non-invasive sensor 5, for example to generate training or validation data for training or testing of a machine learning algorithm and/or to perform the training or testing of the machine learning algorithm. In embodiments, two or more of the processors 33 and 39 can communicate with one another and process data from sensor 5 and from reference sensor 37 together, for example in parallel or in performing different processing steps on said data. Non-invasive sensor 5 and the reference sensor 37 can be operated at overlapping times such that the response signals obtained in operation of the non-invasive sensor 5 have corresponding analyte data obtained by the reference sensor 37.

Data analysis can be performed using any suitable techniques and implementation thereof. As one non-limiting example, signal processing routines can be developed in a Python v3.10.9 environment with Numpy v1.24.1, Pandas v1.5.3, SciPy v1.10.0 and scikit-learn v1.2.1 packages for feature generation in data being processed. After feature generation, regression techniques from the generated features to corresponding analyte measurements can be performed in, for example, Python v3.8.10 with TensorFlow v2.7.0, NumPy 1.21.4 and scikit-learn v1.1.1 packages.

FIG. 3 shows a method of training a machine learning algorithm according to an embodiment. Method 40 includes obtaining signals from a non-invasive sensor 42, obtaining corresponding analyte levels from a reference sensor 44, associating the signals with the corresponding analyte levels 46, processing features of the associated signals 48, and inputting the processed features into a machine learning algorithm 50 to train the machine learning algorithm.

Obtaining signals from a non-invasive sensor 42 includes transmitting a transmit signal into a subject and receiving the response at a receive antenna of the non-invasive sensor. Obtaining the signals at 42 can include generating a transmit signal 52, transmitting the transmit signal into the subject 54, detecting a response resulting from the transmit signal interacting with the subject 56, and obtaining the detected response at a receive circuit at 58. The transmit signal generated at 52 can include a plurality discrete frequencies (i.e. a plurality of discrete frequencies) in a range. The range can be, for example, a range of operation for the non-invasive sensor, a range for detecting the analyte that the machine learning algorithm is being trained to detect. In an embodiment, the range is from about 10 kHz to about 100 GHz. In an embodiment, the range can be from about 300 MHz to about 6 GHz. In an embodiment, the range can be from about 100 MHz to about 4 GHz. In an embodiment, the transmit signal generated at 52 can be a sweep through a range of frequencies. The signal is transmitted into the subject at 54 by way of a transmit antenna, for example, transmit antenna 11 as discussed above and shown in FIGS. 1 and 2A-2C. A response resulting from the transmit signal interacting with the subject is detected at 56 by a receive antenna, such as receive antenna 13 as discussed above and shown in FIGS. 1 and 2A-2C. The detected response is obtained by a receive circuit such as receive circuit 17 discussed above and shown in FIGS. 1 and 2A-2C. In an embodiment, one or more of the frequency sweeps is transmitted into the subject for an extended period of time, for example, over one hour. In an embodiment, one or more of the frequency sweeps is transmitted into the subject for over three hours. The response can be detected at 56 during and following the transmission of the frequency sweep into the subject. In an embodiment, the receive circuit can provide the detected response to a processor for subsequent processing, including, for example associating the signals with the corresponding analyte levels 46, processing features of the associated signals 48, and inputting the processed features into a machine learning algorithm 50 to train the machine learning algorithm. The signals from the non-invasive sensor can be the response to a frequency sweep transmitted by the non-invasive sensor. Each frequency of the frequency sweep can correspond to a feature of the data resulting from the obtaining of signals at 42. For example, where the frequency sweep of the transmit signal is over a range from 500 MHz to 3000 MHz at 1 MHz intervals, the data resulting from obtaining the signals from the response to the non-invasive sensor at 42 can have 2501 features. In another example, the frequency sweep of the transmit signals can be over a range from 500 MHz to 1500 MHz at 0.1 MHz intervals. In this example, the data resulting from obtaining the signals from the response to the non-invasive sensor at 42 can have 10,001 features.

Corresponding analyte levels are obtained from a reference sensor at 44. The corresponding analyte levels are taken from the same subject at the same time as the signals are obtained from the non-invasive sensor. The corresponding analyte levels are levels of the analyte that the machine learning algorithm is being trained on. In an embodiment, the corresponding analyte levels are levels of glucose detected in the subject. The corresponding analyte levels are assumed to be accurate analyte levels for the subject at the time the signals are obtained from the non-invasive sensor at 42. The reference sensor can be any suitable sensor for measuring the analyte for which the machine learning algorithm is trained, such as reference sensor 37 as described above and shown in FIGS. 2A-2C. The reference sensor can be, for example, an invasive sensor. Where the machine learning algorithm is being trained to determine amounts of glucose, the reference sensor can be, for example, a glucose monitor such as the Dexcom® G6 CGM or the Freestyle Libre™. In an embodiment, the reference sensor can be any suitable reference device as set forth by applicable clinical or regulatory standards, such as a laboratory-based glucose measurement where the machine learning algorithm is being trained to determine amounts of glucose.

In an embodiment, the obtaining of the signals at 42 is from a single subject. In an embodiment, the obtaining of the signals at 42 and the obtaining of the corresponding analyte levels at 44 are each performed for each of a plurality of subjects and the signals and corresponding analyte levels are aggregated.

The signals obtained from the non-invasive sensor are associated with the corresponding analyte levels at 46. Each signal obtained by the non-invasive sensor can be labeled with the corresponding analyte level measured as the same time and in the same subject where that signal was obtained, based on the respective times at which the signal was obtained, and when the corresponding analyte was measured.

Features of the signals associated with the corresponding analyte levels are processed 48. The processing of the features can include smoothing of the features. The smoothing can be performed using any suitable filter, such as a low-pass filter or an averaging filter. In an embodiment, the smoothing is performed using a Savitzky-Golay filter. The parameters of the filter can be determined by exploratory data analysis. For example, window sizes from 200 to 2000 and derivative orders from 0 to 2 can be tested to identify parameters for the filter. In an embodiment, the parameters of the Savitzky-Golay filter can be, for example, a window length of 2000, a polynomial order of 4, a derivative order of 1, and using the extension mode “nearest.” The features can be scaled, for example by removing the mean from each feature and dividing by the standard deviation per sample. The feature space can also be reduced during the processing at 48. The reduction of the feature space can be performed so as to reduce dimensionality and/or to reduce or avoid overfitting without removing or washing out effective features. The reduction in feature space can be performed so as to maintain the accuracy of the features and the correlations of those features with corresponding analyte levels. The reduction of the feature space can be performed using any suitable approach, such as Gaussian random projection and/or Gaussian mixture models. In an embodiment, Gaussian random projection can be used to reduce the feature space. In an embodiment, the reduction of features can reduce the number of features to between 2 and 1024 features. In an embodiment, the reduction of features can reduce the number of features to approximately 256 features. In an embodiment, the reduction of features can reduce the number of features by approximately ten-fold, for example reducing 2501 features to 256 features. In embodiments, the number of features can be further reduced, for example to approximately 32 features. In an embodiment, the features can be averaged to reduce the number of variables. Averaging can further reduce noise that may be present among the features. The averaging of the features can be in one or both of a temporal domain and a frequency domain. Features can be averaged in the temporal domain by, for example, calculating a mean of the features over a particular time period, such as averaging within a particular period such as, for example, a five-minute period. Features can be averaged in the frequency domain, for example, by taking a mean over a given range of frequencies, for example averaging the features found in 250 consecutive frequencies to convert the features from having 0.1 MHz intervals to having 25 MHz intervals.

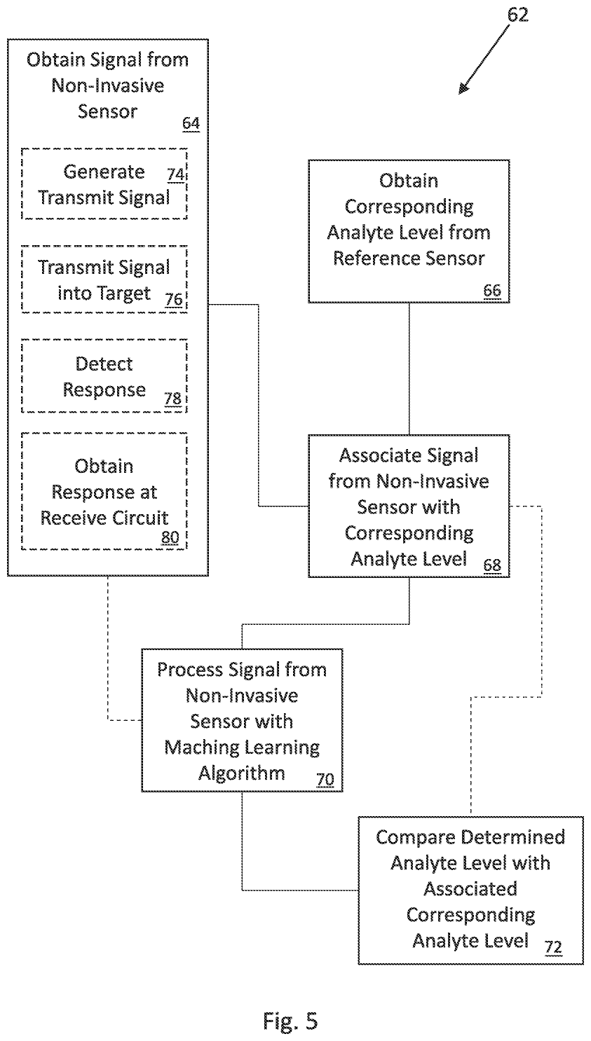

Optionally, the dataset of signals obtained from the non-invasive sensor and associated with the corresponding analyte levels can be divided into a plurality of datasets. In an embodiment, the division of the dataset into the plurality of datasets can be randomized. At least some of the plurality of the datasets can then be used for training the machine learning algorithm by being input at 50. In an embodiment, at least some of the plurality of datasets can instead be used for testing of a trained algorithm, as described below and shown in FIG. 5. In an embodiment, the split of the dataset of signals obtained from the non-invasive sensor can be such that 80% of the signals obtained from the non-invasive sensors are used for training the machine learning algorithm at 50, and the remaining 20% of the signals obtained from the non-invasive sensor being reserved for use as a test dataset.

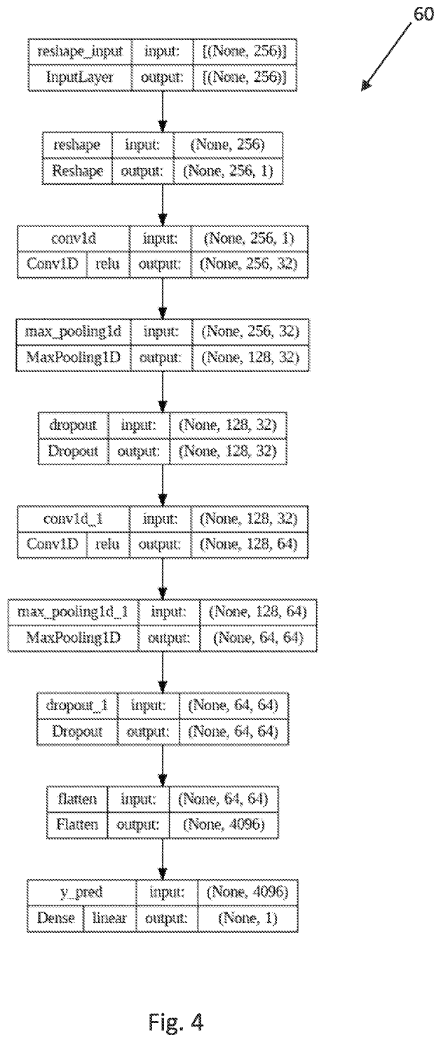

The processed features are input into a machine learning algorithm for training of the machine learning algorithm at 50. The machine learning algorithm can be, for example, a neural network. In an embodiment, the neural network is a convolutional neural network. The architecture and parameters of the neural network can be selected by preparing the algorithm and comparing the validation error of that algorithm determined using baseline data. In an embodiment, model selection and the parameters thereof can be determined by searching possible parameters and comparing results of the models and parameters, for example using any suitable software platform such as a Machine Learning Operations (MLOps) platform. A non-limiting example of such a platform is the MLOps platform from Edge Impulse, Inc. In an embodiment, the baseline data can be a mean of the analyte levels. A schematic of a suitable neural network is shown in FIG. 4. In the example neural network 60 of FIG. 4, there are two blocks each having a one-dimensional convolution layer followed by a pooling layer and finally a dropout layer, with the final layer being a single neuron that is trained to predict the analyte level corresponding to the signal. In embodiments, multiple sets of training data including processed features can be input into the machine learning algorithm to perform the training of the machine learning algorithm. Each set of training data can be one set of signals from the non-invasive sensor that is associated with the corresponding analyte levels and then having the features processed in accordance with the respective steps 46 and 48 as discussed above, and can be used for training of the machine learning algorithm at 50.

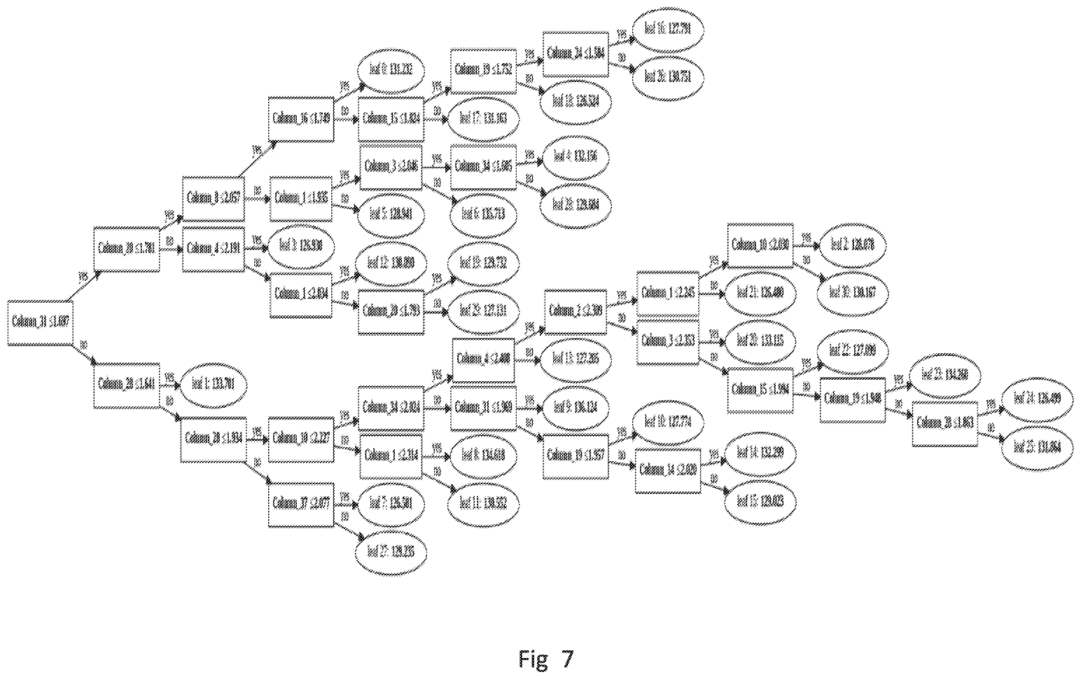

In an embodiment, the machine learning algorithm uses gradient boosting. In an embodiment, the machine learning algorithm is a light gradient boosting machine (lightGBM) model. The lightGBM model can be according to the publication by Ke et al., “LightGBM: A Highly Efficient Gradient Boosting Decision Trec,” Advances in Neural Information Processing Systems 30 (NIPS 2017), which is herein incorporated by reference. In an embodiment, the lightGBM model can be implemented using any suitable software package, such as the lightGBM package in Python. LightGBM models can generate a decision tree in a leaf-wise manner, selecting leaves based on reduction of loss. The loss can be determined based on one or more loss functions. In an embodiment, the Mean Absolute Relative Difference (MARD) can be used as the loss function for the lightGBM model. The MARD can be calculated based on a difference between the outputs of the model and the reference values, such as reference values obtained from an invasive sensor used as the reference sensor. An example of a tree resulting from use of the lightGBM model is shown in FIG. 7. To avoid overfitting, L1, L2, and feature fraction penalties can be used in the lightGBM model. The penalty terms can be tuned using hyperparameter tuning. The lowest MARD achieved for the model can be used to select the final model. As an example embodiment, the respective penalty values used in the model can be L1=0.4, L2=0.4, and feature fraction=0.5.

A machine learning algorithm trained according to method 40 can be used with the same non-invasive sensor used for obtaining the signals at 42, or a different non-invasive sensor of the similar or same design, for example having the same transmit and receive antenna design.

FIG. 5 shows a method for testing a trained machine learning algorithm according to an embodiment. Method 62 includes obtaining signals from a non-invasive sensor 64, obtaining corresponding analyte levels from a reference sensor 66, associating the signals with the corresponding analyte levels 68, processing the signals from the non-invasive sensor using the machine learning algorithm 70 to determine an analyte level, and comparing the determined analyte level from the machine learning algorithm with the associated corresponding analyte level at 72.

The signals can be obtained from the non-invasive sensor at 64 by transmitting transmit signals into the subject and receiving the response from the subject using receive antennas of the non-invasive sensor. Obtaining the signals from the non-invasive sensor at 64 can include generating a transmit signal 74, transmitting the transmit signal into the subject 76, detecting a response resulting from the transmit signal interacting with the subject 78, and obtaining the detected response at 80. The transmit signal can be generated by a transmit circuit such as transmit circuit 15 and transmitted using a transmit antenna 11, as discussed above and shown in FIGS. 1 and 2A-2C. The response can be detected by a receive antenna 13 and the detected response is obtained by a receive circuit such as receive circuit 17, as discussed above and shown in FIGS. 1 and 2A-2C.

Corresponding analyte levels are obtained from a reference sensor at 66. The corresponding analyte levels are taken from the same subject at the same time as the signals are obtained from the non-invasive sensor. The corresponding analyte levels are assumed to be accurate analyte levels for the subject at the time the signals are obtained from the non-invasive sensor at 64. The reference sensor can be any suitable sensor for measuring the analyte for which the machine learning algorithm is being tested. The reference sensor can be, for example, an invasive sensor. Where the machine learning algorithm is being tested to determine the accuracy in determining amounts of glucose, the reference sensor can be, for example, a glucose monitor such as the Dexcom® G6 CGM or the Freestyle Libre™. In an embodiment, the reference sensor can be any suitable reference device as set forth by any applicable clinical or regulatory standards, such as a laboratory-based glucose measurement where the machine learning algorithm is being tested to determine the accuracy in determining amounts of glucose.

The signals obtained from the non-invasive sensor are associated with the corresponding analyte levels at 68. Each signal obtained by the non-invasive sensor can be labeled with the corresponding analyte level measured as the same time and in the same subject where that signal was obtained, based on the respective times at which the signal was obtained, and when the corresponding analyte was measured. In an embodiment, the association of the signals obtained from the non-invasive sensor with the corresponding analyte levels at 68 can be performed prior to processing the signals obtained from the non-invasive sensor to determine an analyte level from the signals obtained from the non-invasive sensor at 70. In an embodiment, the association of the signals obtained from the non-invasive sensor with the corresponding analyte levels at 68 can be performed at an overlapping time to processing the signals obtained from the non-invasive sensor to determine an analyte level from the signals obtained from the non-invasive sensor at 70. In an embodiment, the association of the signals obtained from the non-invasive sensor with the corresponding analyte levels at 68 can be performed at following processing the signals obtained from the non-invasive sensor to determine an analyte level from the signals obtained from the non-invasive sensor at 70. In an embodiment, the results of the association of the signals obtained from the non-invasive sensor are associated with the corresponding analyte levels at 68 can be the input into the machine learning model at 70. In an embodiment, the results of the association of the signals obtained from the non-invasive sensor are associated with the corresponding analyte levels at 68 can be the input when and comparing the determined analyte level from the machine learning algorithm with the associated corresponding analyte level at 72, and the input into the machine learning model at 70 can be the signals are obtained from the non-invasive sensor at 64.

In an embodiment, instead of separately obtaining signals and analyte levels and associating the signals and analyte levels at 64, 66, and 68, one or more data sets generated during the training according to the method 40 discussed above and shown in FIG. 3, but not input into the machine learning algorithm for training at step 50 can instead be used as the testing data to be input into the machine learning algorithm.

The machine learning algorithm processes the portion of the testing data corresponding to the signals obtained from the non-invasive sensor to determine an analyte level from the signals obtained from the non-invasive sensor at 70. The processing at 70 is performed using the trained machine learning algorithm, for example following training of the machine learning algorithm according to method 40 described above and shown in FIG. 3. The analyte levels determined using the machine learning algorithm at 70 are compared to the corresponding analyte levels detected using the reference sensor at 72. The results of the comparison at 72 can be used to determine the accuracy of the machine learning algorithm. For example, a mean absolute error (MAE) can be determined for at least some of the testing data relative to the corresponding analyte levels detected from using the reference sensor at 72. The MAE can be used to select among different models, to compare to a threshold to accept or reject use of a model, or the like. Different portions of test data can be used to perform multiple folds of the determination of the analyte level at 70 and its comparison to corresponding analyte levels at 72. In an embodiment, the validation can be performed using five folds.

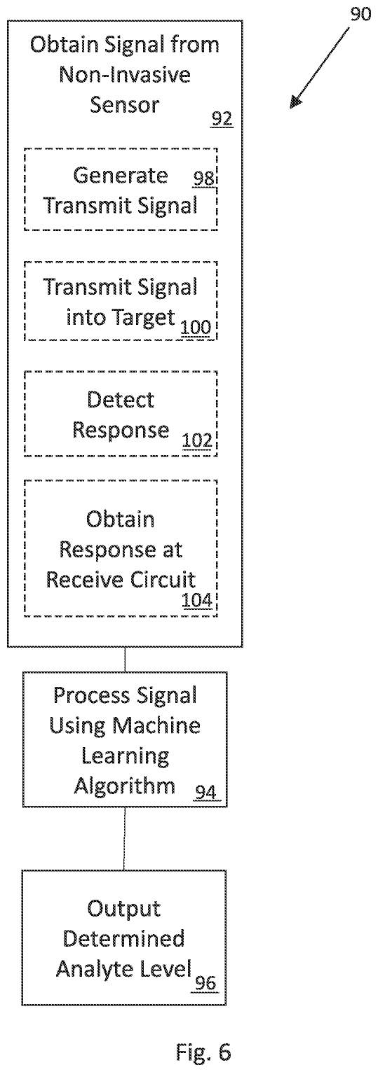

FIG. 6 shows a method of determining a quantity of an analyte according to an embodiment. Method 90 includes obtaining signals from a non-invasive sensor 92, processing the signals using a machine learning algorithm 94 to determine an analyte level, and outputting the analyte level 96.

The signals can be obtained from the non-invasive sensor at 92 by transmitting transmit signals into the subject and receiving the response from the subject using receive antennas of the non-invasive sensor. Obtaining the signals from the non-invasive sensor at 92 can include generating a transmit signal 98, transmitting the transmit signal into the subject 100, detecting a response resulting from the transmit signal interacting with the subject 102, and obtaining the detected response at 104. The transmit signal can be generated by a transmit circuit such as transmit circuit 15 and transmitted using a transmit antenna 11, as discussed above and shown in FIGS. 1. The response can be detected by a receive antenna 13 and the detected response is obtained by a receive circuit such as receive circuit 17, as discussed above and shown in FIG. 1. The subject for the obtaining of the signals at 92 can be a subject in which the analyte is to be detected, for example an end user utilizing the sensor 5 to monitor their glucose levels.

The signal obtained at 92 is processed using a machine learning algorithm at 94. In an embodiment, the processing using the machine learning algorithm is carried out on a controller included in the non-invasive sensor such as controller 19. In an embodiment, the processing using the machine learning algorithm is performed on a controller, such as controller 33, included in an external device 25 or a remote server 27. The machine learning algorithm used to process the signal at 94 can be a machine learning algorithm trained according to method 40 described above and shown in FIG. 3 and/or validated using testing according to method 62 described above and shown in FIG. 5. The machine learning algorithm determines an analyte level for one or more analytes that the machine learning algorithm has been trained to determine from the signal. The determined analyte level is output at 96. Outputting the analyte level can include providing the determined analyte level to a display provided on the sensor 5 or to an external device 25 or remote server 27. The external device 25 or remote server 27 can receive the determined analyte level that is output at 96 and display the determined analyte level, use the determined analyte level to determine alerts or automated actions, or any other suitable response to the determined analyte level.

### Testing Results

Proof of concept for the aforementioned methods to quantify in-vivo blood glucose non-invasively using RF methods by means of training a model to predict readings of a reference sensor as described herein was provided by an observational study. The observational study design collected data every weekday during a 16-day period. Data were simultaneously collected from the prototype device and a reference device during each testing session. To reduce variability in the data, a single individual (the “subject”) was used for all tests. The subject was a 25-35-year-old female in good health. One test was performed each day, making a total of 11 tests. In order to minimize interference in the RF frequencies employed by the antenna, a location was selected in a remote research station in which there were minimal wi-fi, Bluetooth, or other signals. Efforts also were made to limit these signals in the local testing area.

Each test ran for up to four hours and followed a similar procedure. The subject sat in a chair and placed left and right forearms on the prototype antennae of the non-invasive sensor. The subject also was fitted with a minimally invasive CGM reference sensor affixed to the posterior of the left arm to track interstitial glucose levels. To ensure optimal accuracy, the reference sensor was inserted at least 24 hours before testing. After the first reference sensor expired, it was replaced with a new one in the same location. Efforts were made to minimize any body movement of the subject throughout the course of the test.

During 10 of the tests, the subject consumed 37.5 grams of liquid D-Glucose. D-Glucose was administered orally by drinking half of a 75 gram container of Azer Scientific Glucose Tolerance Test Beverage 30 minutes after the test began. During the following 2-3 hours, the subject's glucose levels rose and then fell. The test was stopped after the subject's reference sensor values returned to their “baseline” for 30 minutes. A single test was also conducted in which the subject did not consume D-glucose, but remained on the devices for three hours.

Prototype data was collected on a continuous basis, using sweeps across the 500 MHz-3000 MHz range at 1 MHz intervals, collecting values at 2501 frequencies. A full sweep of these frequencies took approximately seven seconds, including a one second pause between sweeps. Over a typical 3-hour test, just over 1500 sweeps are performed. Each of the 22 tests thus collected approximately 3.8 million pieces of data. For the reference data, glucose values were recorded from the reference device every five minutes for the entire duration of the test; these values were manually entered into a data table that was later used to label the larger datasets. Each test yielded two datasets (prototype, reference).

Feature generation techniques were developed with custom signal processing routines in a Python v3.10.9 environment with Numpy v1.24.1, Pandas v1.5.3, SciPy v1.10.0 and scikit-learn v1.2.1 packages, and then hosted and used to process the raw data in the Edge Impulse platform. After feature generation, regression techniques were employed from the generated features to the reference sensor readings using Python v3.8.10 with TensorFlow v2.7.0, NumPy 1.21.4 and scikit-learn v1.1.1 packages.

The 2501 features of the data were smoothed using a Savitzky-Golay filter with window length of 2000, polynomial order of 4, derivative order of 1 and extension mode ‘nearest’. (Savitzky 1964). Filter windows past the signal boundary were padded by repeating the nearest sample value. Finally, the features were standardized by removing the mean and dividing by standard deviation per sample and then used Gaussian Random Projection to reduce the feature space to 256. The resultant 256 features were computed for each sample and then aggregated before being used as input for machine learning.

The data features were labeled with the result of the reference sensor reading at each time point. From the raw dataset, five separate randomized train/validation splits were generated, each with a different random seed, with two held-out samples per split to use for testing. Each split was then independently trained and evaluated.

In order to establish a baseline ‘model’ to improve upon the mean of the training set labels was chosen. This is analogous to taking a random label in a machine learning classification problem.

After cross-validation, suitable neural network (NN) architectures and hyperparameter settings including a model consisting of two blocks each with a one-dimensional convolution layer followed by a pooling layer and finally a dropout layer was selected as depicted in FIG. 4. The final layer is a single neuron which was trained to predict the value from the reference sensor at each time point.

After the NN was trained, it was applied to the test data, which had been withheld from the model up to this point. For each time point, the NN predicted the reference sensor reading based on the data collected by the sensor, after which it was compared to the value from the reference sensor device. The mean absolute error (MAE) was calculated for each data point. These values were calculated separately for each of five folds. The MAE for the folds was then calculated. The relative error of each prediction was also computed, defined as absolute error divided by the value of the reference sensor reading.

In addition to calculating the MAE, a binary measure of success was also calculated. A prediction is said to be within threshold to the reference sensor value if either: the prediction is within 15% of the reference value for blood sugars over 75 mg/dL; or the prediction is within 15 dmg/dL for blood sugars below 75 mg/dL. (We note that these threshold values are modeled after one of the FDA limits for accuracy in new blood glucose monitors). Statistical significances of differences in means were calculated using two-sample t-tests.

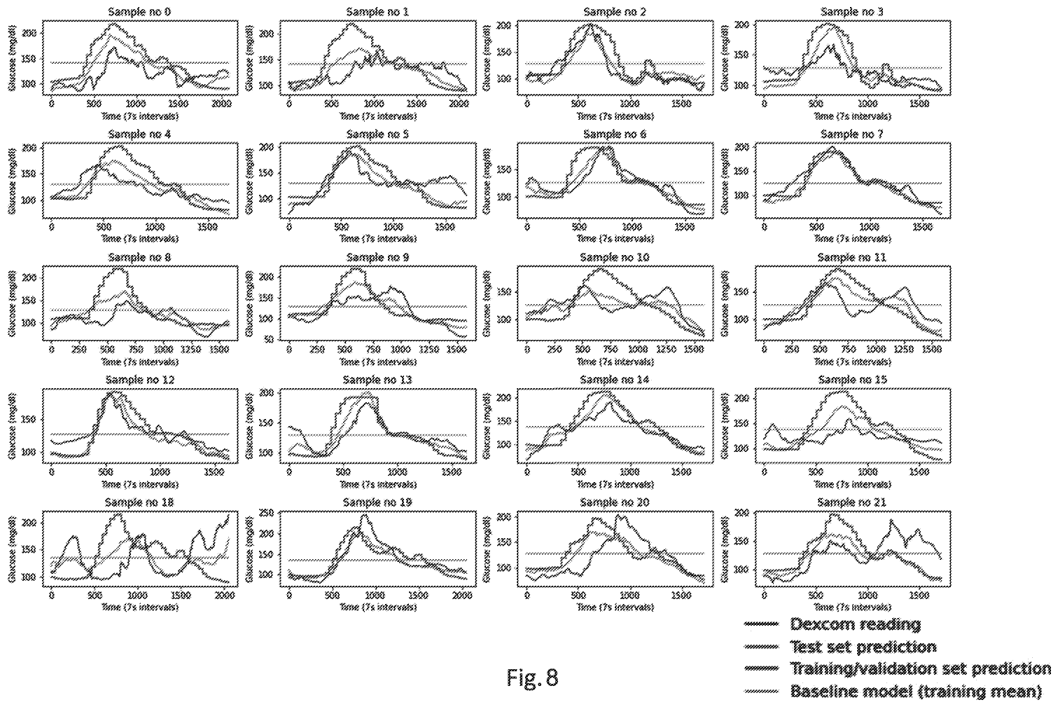

For each of the 20 datasets during which glucose was consumed, reference sensor values were compared with three sets of values calculated for this study: the value of the baseline model, the predictions of the model when that dataset was in the training data, and the predictions of the model when the dataset was in the test data. Results are shown in FIG. 8, which displays the model fit over time for training and test sets compared to the reference values for each test in which the subject consumed glucose.

Summary data regarding model accuracy is given in the table below, which reports the MAE of the baseline and trained models for both the train/validation data and test data for each fold.

| Fold | Training and Validation Dataset | | Test Dataset | |
|---|---|---|---|---|
| number | NN Model | Baseline ‘model’ | NN Model | Baseline ‘model’ |
| 0 | 13.63 | 32.25 | 25.66 | 34.05 |
| 1 | 18.04 | 32.81 | 19.93 | 33.06 |
| 2 | 15.73 | 33.15 | 27.22 | 33.59 |
| 3 | 16.53 | 32.90 | 22.66 | 33.78 |
| 4 | 13.50 | 33.78 | 33.52 | 29.86 |
| mean | 15.49 | 32.98 | 25.80 | 32.87 |
| std | 1.94 | 0.56 | 5.14 | 1.72 |

On the training and validation set, the baseline model had an MAE with a 95% confidence interval of 32.98±1.098. The NN performed significantly better (t=19.36, p<0.001), with an MAE of 15.49±3.80. The baseline model had similar performance on the training and test data. On the test data, the MAE for the baseline ‘model’ was 32.87±3.37. The NN again performed significantly better, with an MAE of 25.80±10.07 (t=2.91, p<0.05). Additionally, it was found that 71% of values in the validation data and 46% of values on held-out test data within threshold (as defined in Section 3.1.3). In the baseline model, by comparison, 26% of values in the test data were within threshold.

The relative errors of the NN model are given for each fold and across all folds in the following table.

| Fold number | Relative error of NN model (%) |
|---|---|
| 0 | 17.46 |
| 1 | 16.46 |
| 2 | 20.33 |
| 3 | 17.04 |
| 4 | 25.85 |
| Mean | 19.3% |

This study presented the results of an n-of-1 study design to assess the potential for using a novel RF-sensor as described herein to quantify blood glucose continuously and non-invasively, with the output of a reference CGM sensor as a proxy for the measurement of blood glucose.

The study utilized a new method that combines novel aspects of data collection utilizing a non-invasive sensor as described herein and Machine Learning techniques. Part of the novelty comes from the study design itself. Data was continually collected over a 2-3 hour period, sampling thousands of frequencies during every six-second sweep, generating a large amount of data. Varying dielectric responses in different frequencies give the neural network model a more nuanced window into the system being scanned and may mitigate some of the limitations of a smaller sample size.

Another way in which this study was different from previous efforts is related to the sensor itself. Typically, antennas in most communication systems are designed to radiate efficiently into free space, and as such, are typically designed to be resonant structures with a specific frequency of operation and radiation pattern in mind. The antenna used in this study, however, is not designed to radiate signals; instead, it is an array of elements which are loosely coupled to each other, where each element is located primarily in the near field of another element in the array. The loosely coupled aspect means that the elements aren't spaced too close together or too far apart. This lets the fields between them occupy the space in “front” of the array, meaning that the material that is placed in front of the array has a significant impact on how the fields behave, and thus on the coupling between the elements. Additionally, because the system operates over a broad frequency range, designing for a specific resonant frequency is not necessary, and designing for efficient coupling of fields into free space for the purposes of propagation is actually counter to the system's goals of coupling energy from one element to another through a material medium.

By combining information from all frequencies collected by the sensor, the resulting NN model demonstrated an error that was significantly smaller than a baseline model. This is especially promising given the limited tests available for this initial study. Neural network models thrive on large amounts of data, and the efficacy of the model discussed in this work is based on only 11 tests, yielding 22 sets of data (one for each arm) is encouraging.

FIG. 8 shows how well each of the datasets was tracked by the model over time. Visually, one can see that the performance of the model varied significantly depending on the sample. Encouragingly, some of these samples were modeled extremely closely in both the training and test sets, while others showed strong variation from the actual values. This may suggest underlying environmental or physiological differences in these tests.

The accuracy (as measured by size of error) of the predictions in this n-of-1 study are quite encouraging. A clinically useful non-invasive blood glucose sensor should make predictions within threshold (see Section 3.1.3) 95% of the time. With a mean relative error of 19.3%, this study has begun to move toward that goal. While just 46% of values on test data met were within threshold, this provides a floor against which to measure future work.

In the future, studies collecting data from multiple participants can be conducted, and the data preparation and machine learning methods with continue to be refined to hone the model further.

The results of this initial study will lead to a new method of quantifying blood glucose. The study used a new type of sensing device combined with machine learning techniques to build an NN model to predict reference sensor readings as a proxy for BGL on one individual over a series of tests. The data were split between test and training sets; the model was trained on the latter and tested on the former. The model shows promise, with a mean absolute error on the test set of 25.80 mg/dL (relative error 19.3%). Future work will expand data collection to multiple individuals in order to refine this model and increase the accuracy.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A method of detecting a level of an analyte, comprising:
transmitting a transmit signal into a subject using a transmit antenna of a non-invasive sensor;
obtaining a response signal from the subject using a receive antenna of the non-invasive sensor; and
processing the response signal using a machine learning algorithm to determine a level of an analyte in the subject, wherein the machine learning algorithm is trained by:
transmitting a frequency sweep into a test subject using a transmit antenna of a test non-invasive sensor;
obtaining a test response to the frequency sweep from the test subject using a receive antenna of the test non-invasive sensor;
obtaining a test analyte level in the test subject using a reference sensor;
associating the test response with the test analyte level;
processing features of the test response to generate training data; and
inputting the training data into the machine learning algorithm.

2. The method of claim 1, wherein the machine learning algorithm is a neural network.

3. The method of claim 2, wherein the neural network includes two blocks each with a one dimensional convolution layer, the two blocks followed by a pooling layer, a dropout layer, and a neuron trained to predict the level of the analyte based on the response signal.

4. The method of claim 1, wherein the processing of the features includes smoothing of the features using a Savitzky-Golay filter.

5. The method of claim 4, wherein the parameters of the Savitzky-Golay filter include a window length of 2000, a polynomial order of 4, a derivative order of 1, and using the extension mode nearest.

6. The method of claim 1, wherein the processing of the features includes reducing a feature space using Gaussian random projection and/or a Gaussian mixture model.

7. The method of claim 6, wherein the feature space is reduced to between 2 and 1024 features.

8. The method of claim 1, wherein the frequency sweep is at 1 MHz intervals within a range of frequencies.

9. The method of claim 1, wherein following training of the machine learning algorithm, the machine learning algorithm is tested by:
obtaining a validation signal using a validation non-invasive sensor;
obtaining a corresponding validation analyte level;
determining an output analyte level based on the validation signal, using the machine learning algorithm, and
comparing the output analyte level with the validation analyte level.

10. The method of claim 1, wherein at least a portion of the response signal is received from interstitial fluid of the subject.

11. The method of claim 1, wherein processing features of the test response includes averaging features over at least one of a frequency domain or a time domain.

12. The method of claim 1, wherein the machine learning algorithm is a light gradient boosting machine model.

13. The method of claim 12, wherein a loss function of the light gradient boosting machine model is based on a mean average relative difference relative to the test analyte level.

14. A method of training a machine learning algorithm to detect a level of an analyte in a subject, comprising:
transmitting a frequency sweep into a test subject using a transmit antenna of a test non-invasive sensor;
obtaining a test response to the frequency sweep from the test subject using a receive antenna of the test non-invasive sensor;
obtaining a test analyte level in the test subject using a reference sensor;
associating the test response with the test analyte level;
processing features of the test response to generate training data; and
inputting the training data into the machine learning algorithm.

15. The method of claim 14, wherein the processing of the features includes smoothing of the features using a Savitzky-Golay filter.

16. The method of claim 15, wherein the parameters of the Savitzky-Golay filter include a window length of 2000, a polynomial order of 4, a derivative order of 1, and using the extension mode nearest.

17. The method of claim 1, wherein the processing of the features includes reducing a feature space using Gaussian random projection and/or a Gaussian mixture model.

18. The method of claim 17, wherein the feature space is reduced to between 2 and 1024 features.

19. The method of claim 14, wherein the frequency sweep is at 1 MHz intervals within a range of frequencies.

20. The method of claim 14, wherein processing features of the test response includes averaging features over at least one of a frequency domain or a time domain.

21. A non-invasive analyte sensing system, comprising:
a transmit antenna configured to transmit a transmit signal into a subject;
a receive antenna configured to obtain a response signal from the subject; and
a controller configured to process the response signal using a machine learning algorithm to determine a level of an analyte in the subject. wherein the machine learning algorithm is a neural network.
